(19) United States
(12) Patent Application Publication
(10) Pub. No.: US 2009/0228328 A1
(43) Pub. Date: Sep. 10, 2009

(54) Method and Apparatus for Quantifying Aesthetic Preferences in Product Design Using Production Rules

(76) Inventors: Jonathan Cagan, Pittsburgh, PA (US); Seth D. Orsborn, Rolla, MO (US); Peter Boatwright, Cranberry Township, PA (US)

Correspondence Address: JONES DAY, 222 EAST 41ST ST, NEW YORK, NY, 10017, US

(21) Appl. No.: 12/226,716

(22) PCT Filed: Apr. 27, 2007
(86) PCT No.: PCT/US2007/010345

§ 371 Date: May 7, 2009

Related U.S. Application Data
(60) Provisional application No. 60/795,291, filed on Apr. 27, 2006.

(51) Int. Cl. G06Q 10/00; G06F 19/00; G06F 15/18

(52) U.S. Cl. 705/10; 700/103; 706/12

(57) ABSTRACT

A computer implemented method includes performing a statistical analysis on a database of product shape information and identifying product characteristics based on statistical relationships among the shapes in the product database. A plurality of production rules that express the allowable variations of shapes defining the product characteristics is generated, and the generated rules are saved in a database for use in generating product designs according to the application of the rules. Another aspect of the invention is directed to a method which includes enabling a plurality of characteristic software agents to control the application of production rules to that agent's assigned characteristic so that each characteristic software agent generates a portion of a candidate design; determining if each of the portions of a candidate design is to be saved; saving a plurality of completed candidate designs; soliciting consumer responses to the plurality of candidate designs; and performing an analysis of the consumer responses to identify consumer preferences.

### CROSS-REFERENCE TO RELATED APPLICATIONS

This application claims priority from U.S. Provisional Patent Application number 60/795,291, filed Apr. 27, 2006, which is hereby incorporated by reference in its entirety.

### GOVERNMENT RIGHTS

This invention was made with partial government support under National Science Foundation No. DMI-0245218. The government has certain rights in this invention.

### BACKGROUND

The present invention relates generally to computer-aided design software and market research techniques and more particularly to systems and methods for tracking and quantifying user aesthetic preferences for individual or combinations of design features.

Typical prior art methods for understanding a user's aesthetic preference employ focus groups and interviews. Semantic differential [Osgood, C., Suci, G. and Tannebaum, P., 1957, The Measurement of Meaning, University of Illinois Press, Urbana, Ill.], a commonly used method, provides a method for understanding people's preference using descriptive words. Aesthetic preference is described using abstract, subjective terms, i.e. soft vs. hard, which are then subjectively translated by the designer.

Utility functions [von Neumánn, J. & Morgenstern, O., 1944, Theory of Games and Economic Behavior, Princeton University Press, Princeton, N.J.] are used to measure and/or convey preference. Keeney & Raiffa [Keeney, R. L., and Raiffa, H., 1976, Decisions with Multiple Objectives: Preference and Value Tradeoffs, Cambridge University Press, New York, N.Y.] first formalized their use as a marketing tool for understanding consumer preference. In the field of engineering design, utility functions have been used to understand consumer preference [Michalek, J. J., Feinberg, F. M., and Papalambros, P. Y., 2005 “Linking marketing and engineering product design decisions via analytical target cascading,” Journal of Product Innovation Management, Vol. 22, pp. 42-62], design preference in engineering design [Li, H. and Azarm, S., 2000, “Product Design Selection Under Uncertainty and with Competitive Advantage,” Journal of Mechanical Design, 122(4), pp. 411-418; Li, H. and Azarm, S., 2002, “An Approach for Product Line Design Selection Under Uncertainty and Competition,” Journal of Mechanical Design, 124(3), pp. 385-392; Otto, K. and Antonsson, E., 1994, “Modeling Imprecision in Product Design,” Proceedings of the 3^{rd} IEEE International Conference on Fuzzy Systems, Vol. 1, pp.346-351; Scott, M. and Antonsson, E., 1995, “Aggregation Functions for Engineering Design Trade-offs,” Fuzzy Sets and Systems, 99(3), pp. 253-264; Thurston, D., 1991, “A Formal Method for Subjective Design Evaluation with Multiple Attributes,” Research in Engineering Design, 3(2), pp. 105-122].

### SUMMARY

One embodiment of the present invention starts by focusing on shape data for a product class, namely a set of products that are similar in general form and purpose but vary by form details. Product characteristics are extracted from the shape data. Each characteristic is composed of one or more shapes needed to define that characteristic. Production rules, e.g. a shape grammar, are built which expresses the allowable transformations for shapes defining the product characteristics. At this point, in one embodiment of the present invention, an initial preference function, e.g. a utility function, can be defined through a variety of ways, i.e., statistical analysis, prior design knowledge, an intelligent guess, etc. For example, using multi dimensional scaling of the normalized characteristic shapes, the principal components of the product class are found in order to understand which shapes are similar across the products and which shapes are differentiators. The shapes with the strongest similarity and the strongest differentiation are compiled into an initial utility function. This initial utility function describes the shapes that are most effective at changing the design. The shape grammar is then built. One manner of using the shape grammar to generate candidate designs is through the use of software agents. “Agents”, as that term is used herein, refers to any software component, module, routine, function, among others, capable of performing the necessary functions for the task at hand. “Agents” is not intended to be used in a narrow, technical sense. The agents, using the initial utility function, create a set of candidate designs which are then presented to the user. From the user feedback such as responses to a survey, the initial utility function can be modified such that the agents can produce a now set of designs. If a utility function was not initially derived, the previously mentioned statistical analysis can be applied to the user feedback. This statistical analysis then supplies the information for the utility function. Through an iterative process, the utility function is modified to describe the design preference(s) of the user(s). In that manner, we are able to capture and use individual as well as group preferences on the acatual form or shape of a design

In identifying the characteristic shapes and developing the shape grammar, data may be collected that mathematically represent the shapes for the products in focus. For example, key product form features may be represented using Bezier curves. Bezier curves are composed of control points that have coordinate representations. Another example would be to represent distinguishing shapes with primitives, such as cubes, cylinders, or spheres, which can then be represented numerically. This data representing the shapes is generalized to create the shape grammar and it is separately analyzed to statistically determine the clusters of similar and dissimilar features. The data can be used for statistical analysis and shape grammar creation continuously or discretely.

### BRIEF DESCRIPTION OF THE DRAWINGS

For the present invention to be easily understood and readily practiced, the present invention will now be described, for purposes of illustration and not limitation, in conjunction with the following figures, wherein:

FIGS. 1A, 1B and 1C present potential sequences for the construction and interaction of the method disclosed herein.

FIGS. 2A, 2B, and 2C show an example shape grammar rule derivation from principal components.

FIG. 3 illustrates an agent-based method of using a shape grammar to generate candidate designs.

FIG. 4 shows a first principal component.

FIG. 5 shows a second principal component.

FIGS. 6A, 6B, and 6C show a sample survey question.

FIG. 7 shows an exemplary best design.

FIG. 8 illustrates hardware upon which the method of the present invention may be employed.

### DETAILED DESCRIPTION

The present invention extends the application of shape grammars [Stiny, G., 1980 “Introduction to shape and shape grammars,” Environment and Planning B, 7(3), pp. 343-351], a geometry-based production system, to both automatic generation with computer-based agents, and also for use in capturing individual or group aesthetic preferences. In the current state of the art, shape grammars are implemented through a computational interface. There has been recent work using evolutionary algorithms in conjunction with shape grammars to explore a design space [Reddy, G., and J. Cagan, “Optimally Directed Truss Topology Generation Using Shape Annealing,” ASME Journal of Mechanical Design, Vol 117, No. 1, pp. 206-209, 1995; Shea, K., J. Cagan, and S. J. Fenves, “A Shape Annealing Approach to Optimal Truss Design with Dynamic Grouping of Members”, ASME Journal of Mechanical Design, Vol 119, No. 3, pp. 388-394, 1997, Chouchoulas, O., 2003 “Shape Evolution: An Algorithmic Method for Conceptual Architectural Design Combining Shape Grammars and Genetic Algorithms,” Department of Architectural and Civil Engineering, University of Bath; Gero, J. S., et. al., 1994 “Evolutionary learning of novel grammars for design improvement,” AIEDAM, 8(2), pp. 83-94; Lee, H. C., and Tang, M. X., 2004 “Evolutionary shape grammars for product design,” 7^{th} International Conference on Generative Art, Politecnico di Milano University; Renner, G. and Ekart, A., 2003 “Genetic algorithms in computer aided design,” Computer Aided Design, 35(8), pp. 709-726]. One embodiment of the present invention incorporates a computational user interface while generative agents [Olson, J., and Cagan, J., 2004 “Interagent ties in team-based computational configuration design,” AIEDAM, 18(2), pp. 135-152] explore the design space. It has been shown that agents are able to broadly and deeply explore the design space using a combination of search strategies, knowledge about the problem and design methods, and collaborative strategies [Campbell, M., et. al., 2003 “The A-Design approach to managing automated design synthesis,” Research in Engineering Design, 14(1), pp. 12-24; Olson, J., and Cagan, J., 2004 “Interagent ties in team-based computational configuration design,” AIEDAM, 18(2), pp.135-152].

The present invention also extends the use of statistical methods to direct the use of shape grammars, which will be discussed in detail later. Previously, the constraints of the parametric application of the shape grammar were determined by the creator of the grammar. In the present invention, a statistical analysis of the product characteristics, or of the user's preferences, may be used to determine groupings of elements of the shape grammar and the composition of the user's or target customer's utility function. The statistical technique chosen for one embodiment of the present invention is principal component analysis. Principal component analysis is a statistical method whereby an original set of related data is reduced in dimensionality with as little loss of information as possible from the original data [Patel, N., Shmueli, G. and Bruce, P., 2006, Data Mining in Excel, Resampling Stats, Inc., Arlington, Va., pp. 39-46]. Other statistical and/or multi-dimensional scaling methods could also be used, such as decision tree analysis or factor analysis, or another multi-variant analysis of shape information of the associations among shapes.

In one embodiment of the present invention, the utility function is composed of groupings of features that statistically are similar in their influence on aesthetic preferences. The groupings may not be obvious and may include discontinuous geometries from different attributes. This method eliminates the need for the designer to infer what aesthetic preference is favored. New designs, based upon a derived aesthetic preference, can then be guaranteed to fall within (or without, if desired) specified forms. Overall, this should eliminate the guesswork on the aesthetics of product design by changing the design descriptors from subjective terms to objective numbers. It should shorten the product development time by eliminating the need for multiple iterations of user studies. Product here can refer to a physical product, a part, a branding reference, a symbol, or other entities represented by geometric form.

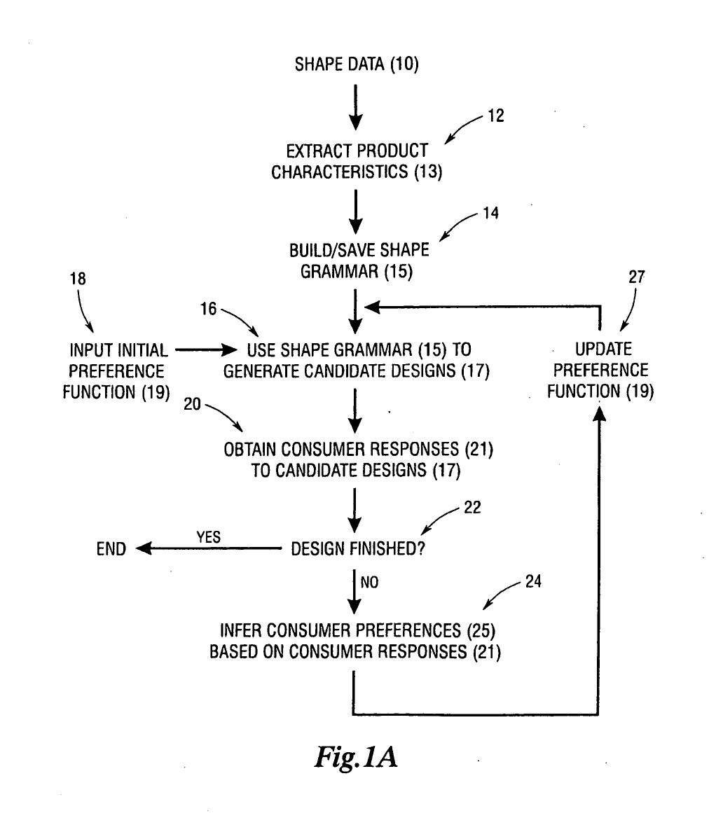

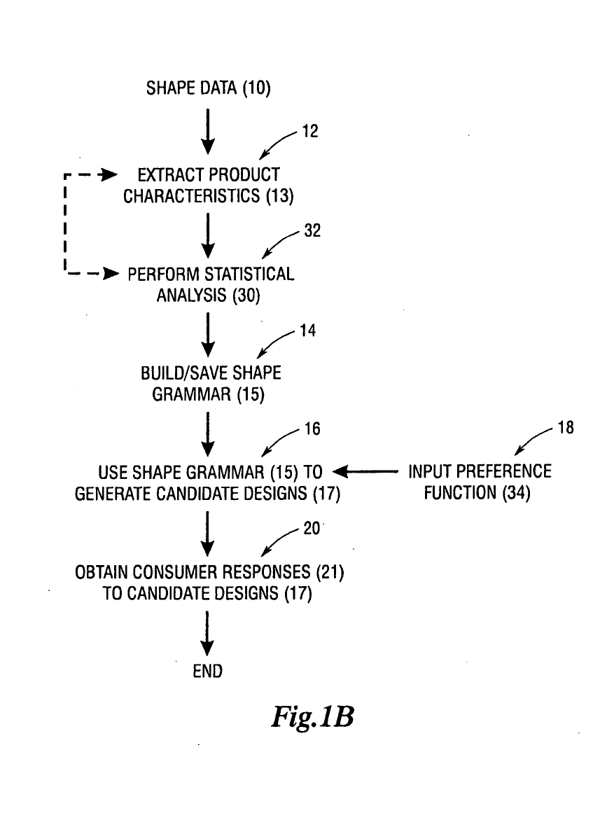

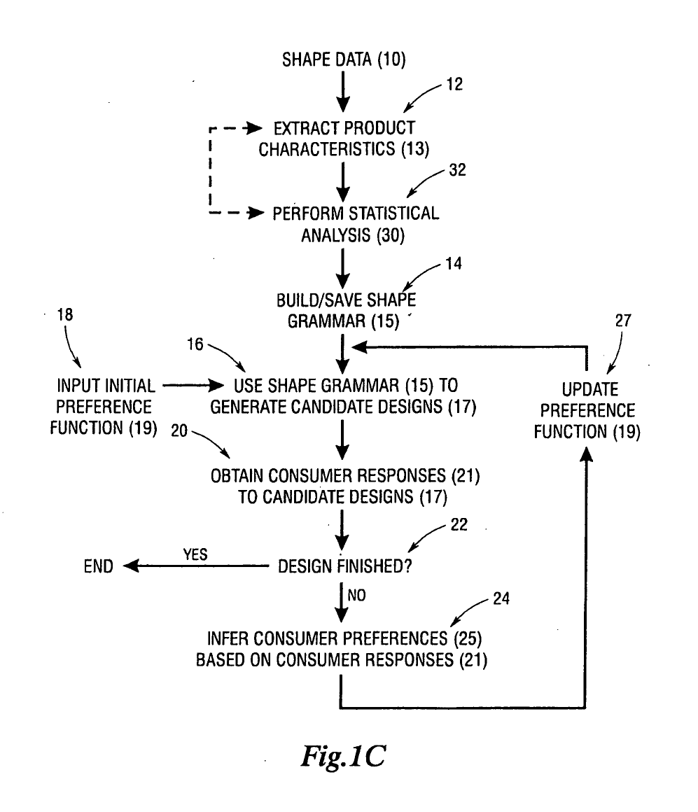

Turning now to FIGS. 1A, 1B, and 1C, there are a number of steps that comprise the method of the present invention. These steps will be individually discussed in more detail later. As can be seen in FIGS. 1A, 1B, and 1C, these steps can be applied in several distinct orders that will provide different results.

In FIG. 1A, shape data 10 is provided. Product characteristics 13 can be extracted or otherwise identified, at step 12, from the shape data 10. The product characteristics 13 are then used to build, compile, or otherwise generate, at step 14, a shape grammar 15. At step 16, the shape grammar 15 is used to generate candidate designs 17. The candidate designs are generated by the shape grammar 15 using an initial preference function 19 input at step 18. The candidate designs 17 are presented in step 20 to one or more consumers and the consumers' responses 21 obtained. At step 22 a determination is made if the process is completed, i.e., does one or more of the candidate designs satisfy some criterion? If yes, the process ends. If no, at step 24 the consumers' preferences 25 can be inferred, statistically analyzed, or otherwise determined based on the consumers' responses 21. The consumers preferences 25 can then be used at step 27 to update the preference function 19

In FIGS. 1B and 1C, like steps and elements are given the same reference numerals as the reference numerals used in FIG. 1A. In FIG. 1B, the shape data 10 is used in the extraction step 12 to define the product characteristics 13. A statistical analysis 30 is performed at step 32 on the product characteristics 13. The results are then used at step 14 to build the shape grammar 15. A preference function 34 is input at step 18, and the shape grammar 15, using the preference function 34, generates candidate designs 17 at step 16. The candidate designs are presented to the consumers at step 20 and the consumer responses 21 to the candidate designs 17 are obtained. Note that in this embodiment, the sequence of steps 12 and 32 may be reversed.

In FIG. 1C, shape data 10 is provided. The product characteristics 13 are extracted from the shape data 10 at step 12. A statistical analysis 30 of the product characteristics 13 can be performed at step 32 and the results used to build or compile, at step 14, the shape grammar 15. Thereafter, the process is the same as the process discussed above in conjunction with FIG. 1A. Note that in the process of FIG. 1C, the sequence of steps 12 and 32 may be reversed.

It should be recognized that although the methods of FIGS. 1A-1C will be implemented, to the extent possible, through the use of computers, certain steps can be performed manually or with the aid of a computer. For example, the step 12 of extracting product characteristics 13 will likely be performed by a computer, but can be performed manually. Similarly, the step 32 of performing the statistical analysis 30 will likely be performed by a computer, but can be performed manually. Thus, references to a method as being computer implemented should be understood to mean that at least one step is performed on a computer.

Turning now to a more detailed explanation of each of the components and steps, the first step to building a shape grammar is to define the vocabulary for the shape language [Stiny, G., 1980 “Kindergarten grammars: designing with Froebel's building gifts,” Environment and Planning B, 7(4), pp. 409-462]. A suitable sample of the language can be used and it is up to the builder to determine what representation of the language is reasonable for the desired task. The sample should be broad (represent as many different products as possible) and deep (represent the essential details of the form) enough to sufficiently capture the language. The sample should be in a form that is measurable. This can include, but is not limited to: points, straight lines, Bezier curves, planes, Bezier surfaces and volumes. This can be represented in 1-D, 2-D or 3-D. Each figure in the sample should then be represented with the chosen shapes. The description of these shapes is the shape data 10. In one example, the sample chosen was 42 vehicles from the 2003 model year. The characteristics represented were the track width, wheel base, rim radius, and tire radius. All are represented with vectors.

The shape data 10 could then be evaluated so that the extracted parametric ranges for each shape can be defined. Any other shape relationships could also be defined, such as continuity, which can help simplify the shape representation as will be shown in the example.

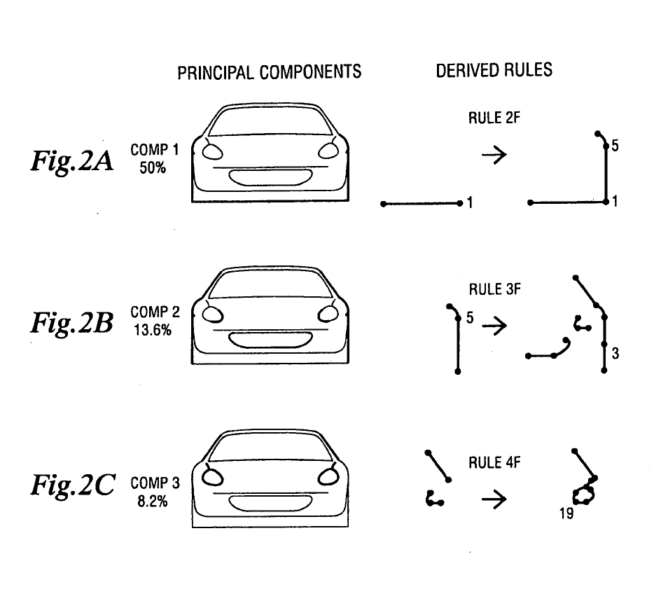

The next step is to combine the shapes into shape groupings called product characteristics 13. The shapes may be grouped functionally, according to aesthetic relation, or any other way seen fit by the builder. As stated previously in conjunction with FIGS. 1B and 1C, the product characteristics 13 could also be defined according to the results of a statistical analysis 30 of the shape data 10. This would produce product characteristics 13 that are grouped according to statistical relations. For example, if a class of products is analyzed using principal component analysis, the distinguishing features can be determined. In one example, 20 coupes from the 2003 model year were analyzed using principal component analysis. The first principal component in the front view explained 50.0% of the variation between the vehicles, the second 13.6%, and the third 8.2% (FIGS. 2A, 2B, and 2C, respectively). A rule is then derived so that the right-hand side is composed of the distinguishing curves from a principal component and the left-hand side is composed of distinguishing curves shared between two principal components. For example, in FIG. 2B, the left-hand side of Rule 3F is composed of the shoulder and body width, which are the two curves shared by both principal component 1 and principal component 2. The right-hand side of Rule 3F is composed of all the curves in principal component 2. Again, in FIG. 2C, the left-hand side of Rule 4F is composed of the curves representing the outside of the upper half of the vehicle and the inner and bottom of the headlight. These curves are shared by both the second and third principal components. The right-hand side of Rule 4F is composed of all the representative curves in principal component 3.

In the main example, the example involving the 42 vehicles, the characteristic groupings were formed according to commonly accepted vehicle features, i.e. track width and wheel base.

As per FIGS. 1A-1C, using the vocabulary, the builder could build the shape grammar 15 [Stiny, G., 1980 “Introduction to shape and shape grammars,” Environment and Planning B, 7(3), pp. 343-351]. The shape grammar 15 can be built directly from the product characteristics (FIG. 1A), or from a statistical analysis of the product characteristics (FIGS. 1B and 1C). The latter will direct the shape grammar to be constructed in a way that defines the rules according to the results of the statistical analysis, which was discussed earlier. The shape grammar 15 could, but does not have to, use labels to keep track of the rule progression and the creation of shape characteristics. In the main example, labels are used to prevent certain shapes from being created in an inappropriate sequence. If desired, a set of universal shape modification rules can be created. This was done in the main example.

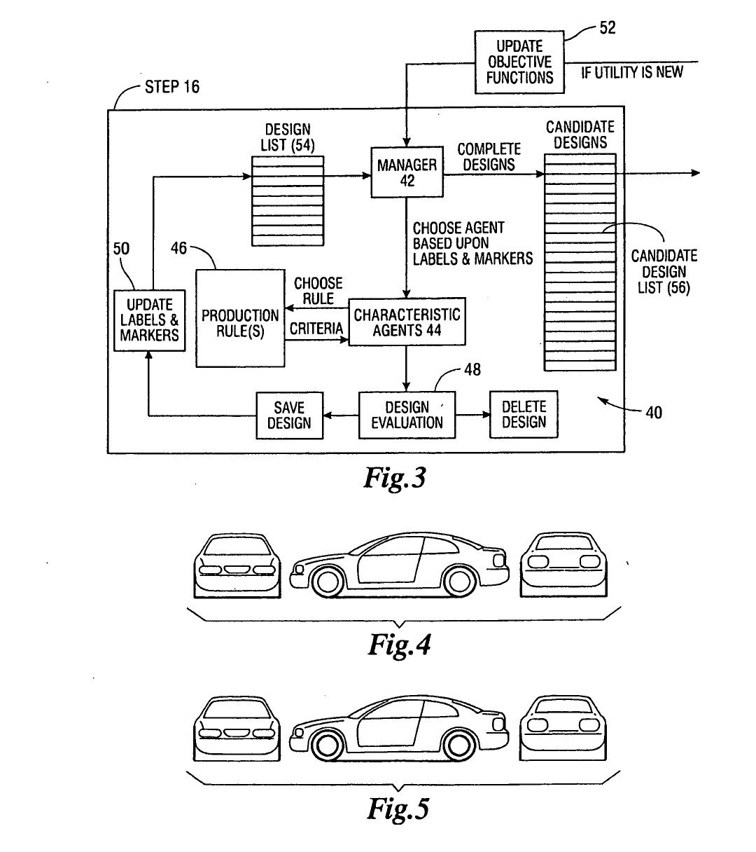

The shape grammar 15 may then be used at step 16 through an agent-based program [Campbell, M., et. al., 2003 “The A-Design approach to managing automated design synthesis,” Research in Engineering Design, 14(1), pp. 12-24; Olson, J., and Cagan, J., 2004 “Interagent ties in team-based computational configuration design,” AIEDAM, 18(2), pp. 135-152]. Here, the representation that the agents act on is the shape grammar 15. A combination of hardware and software 40, outlined in FIG. 3 and discussed in the following section, is composed of a manager agent 42 and a characteristic agent 44 for each characteristic 13. The manager agent 42 oversees the design process, keeps track of active labels and markers, current designs, completed designs, and their associated objective functions in various memory locations. The characteristic agents 44 are responsible for the implementation of the rules, the allowable parametric ranges for their shapes, and their relationship with other agents. Each rule that is written in the shape grammar should be created as its own rule in the program. All the rules related to a certain characteristic could be grouped under the characteristic agent 44 that represents that characteristic 13. Rules that are used by more than one characteristic agent 44, such as shape modification rules, should be placed more generally, such as directly under the manager agent 42.

FIG. 3 outlines one example of the device 40 that may be used to implement step 16. The manager agent 42 receives a set of parametric constraints derived from the shape data 10. This input may be statistically analyzed and used to create an initial utility function, which will be discussed in further detail later. The manager agent 42 then chooses, e.g. stochastically, a characteristic agent 44 possibly, and in this embodiment, based upon which label is active. If there are no active labels, then the characteristic agent 44 is chosen based upon which curves have been created arid which characteristics are complete. The chosen characteristic agent 44 then chooses, e.g., stochastically, a rule from a database 46 of available rules. This rule is then applied within the allowable parametric ranges extracted from the shape data 10. The rule returns the suggested criteria for changes to the shape back to the characteristic agent 44. The characteristic agent 44 determines the shape based upon the characteristic agent's 44 objective function. The objective function is determined by design history and any user influence, to be discussed later. The characteristic agent 44 passes its design suggestion to the design evaluation module 48. It is now determined whether to save or delete the design. If the design is saved, the labels and markers are updated 50, and the design is added to the designs lists 54. The manager agent 42 then takes incomplete designs from the designs list 54 and starts the process over again. If a design is completed, it is passed to the candidate designs list 56 and stored until the list 56 reaches a predetermined quota. If the design is not completed, the manager agent 42 restarts the design cycle based upon the active labels or other criteria

The set of candidate designs 17 are evaluated at step 20 (see FIG. 1) in which consumer responses 21 are obtained. The consumer responses 21 can than be used to infer consumer preferences 25 at step 24, and the consumer preferences 25 can be used to update the preference function 19. The inference of consumer preferences 25 can be based on a statistical analysis, and the results of that statistical analysis used to update the preference function, which will be discussed in more detail later. After the preference function is updated, the preference function is passed back to the manager agent 42. The manager agent 42 then restarts the design cycle based upon the new preference function.

In the steps 20 and 24 (see FIG. 1), consumer preferences (25) may be determined, for example through a stated-preference choice-based conjoint survey [Page, A. L. and Rosenbaum, H. F., 1987, “Redesigning Product Lines with Conjoint Analysis: How Sunbeam Does It,” Journal of Product Innovation Management, 4(2), pp. 120-137]. One manner in which consumer preferences 25 may be utilized is to use the consumer preferences 25 to define a utility function, which is one type of a preference function. Other types of preference functions, such a value functions or preference orderings, and metrics, among others, may be used. Other methods for obtaining the utility function may be employed, such as. a random sampling from a multivariate distribution [Green, P. and Srinivasan, V., 1978, “Conjoint Analysis in Consumer Research: Issues and Outlook,” Journal of Consumer Research, 5(Sept.), pp. 103-123]. It has been shown that a pictorial representation is sufficient for gauging customer reactions using this type of survey [Page, A. L. and Rosenbaum, H. F., 1987, “Redesigning Product Lines with Conjoint Analysis: How Sunbeam Does It,” Journal of Product Innovation Management, 4(2), pp. 120-137]. In the main example, the customer is shown three vehicles and must choose which one is preferred.

The statistical analysis 30 of the shape data 10 can be done at several different places in the design cycle as shown in FIGS. 1A-1C and discussed earlier, and for different purposes. One purpose is to extract the product characteristics; a second purpose is to define the preference function, e.g., a utility function. At which point in the process the analysis is done to define the preference function will have an impact on the composition of the preference function. The two purposes can be combined. For example, the analysis may use a multi-dimensional scaling of the normalized shape data 10. Then, the principal components are found in order to understand which shapes are similar across the designs, which shapes are differentiators, and how they are related. The set of shapes in the principal component could be simplified to the most distinguishing attributes, those with the highest weights, using a Scree plot, taking the top percentage, or other technique [Johnson, R. A. and Wichern, D. W., 1982, Applied Multivariate Statistical Analysis, Prentice-Hall, Englewood Cliffs, N.J.]. The shapes with the strongest similarity and the strongest differentiation are compiled into a preference function. Other statistical tools known to those skilled in the art could be used to understand the differentiating characteristics of the design, such as decision tree analysis.

In the main example, the statistical analysis to define the utility function was done after the shape grammar was implemented (see FIG. 1A). As mentioned, there were 42 vehicles in the sample used to extract the data. Four product characteristics were considered: wheelbase, track width, rim radius, and tire radius. The characteristic shapes were normalized to prevent the analysis from being skewed towards larger shapes like wheelbase. A multi-dimensional analysis was performed which determined the number of principal components needed to describe the differences between the vehicles with a total of four. Each principal component was also assigned a percentage of variance explained, that is, how much of the variation between the products is described by that principal component. It was determined to keep the top two principal components. Other techniques known to those skilled in the art could be used, such as Kaiser's Criterion [Kaiser, H. F. and Rice, J., 1974, “Little Jiffy. Mark IV.,” Educational and Psychological Measurement, Vol. 34, pp. 111-117]. It was then determined to keep the top 3 attributes within each principal component. As stated earlier, other techniques could be used to determine which attributes dominate each principal component. The first principal component explained 64.3% of the variation between the vehicles and was composed of the track width, the wheel base, and the tire radius (FIG. 4 highlighted with thicker lines). The second principal component explained 18.9% of the variation between the vehicles and was composed of the rim radius, the tire radius, and the track width (FIG. 5 highlighted with thicker lines). These vehicle characteristics were then included as terms in the utility function. These terms were the focus of the characteristic agents 44 when determining the user's aesthetic preference.

This statistical analysis can be done with the initial design sample (FIGS. 1B and 1C), which will force the utility function to be composed of the correlated product characteristics. This method is preferred for understanding the relationships among a sample of designs because it forces the shape grammar 25 to be constructed according to these shape relationships. The analysis can also be done on the top designs chosen by the user, which will force the utility function to be composed of the characteristics preferred by the user. This method is preferred for understanding a user's aesthetic preference.

From either statistical analysis, the shapes that are most important are determined, as described previously. These shapes are then collected into a utility function. The utility function is composed of the preferred characteristic terms and their respective descriptive weights: U=ΣwᵢPCᵢ, where wᵢ is the weighting term and PCᵢ is the term describing the principal component. In the main example, a user's utility function may be composed of the track width, wheel base, rim radius, and tire radius or the utility function may be composed of combinations of characteristics such as the track width, wheelbase, tire radius as one component and the rim radius, tire radius and wheel base as another. These characteristics are then described by an individual term of the overall utility function that is derived from the characteristic's objective function, which is kept by the manager agent 42. In the example, the utility function takes a quadratic form, shown to be sufficient for most applications [Chen, W., Wiecek, M. M., and Zhang, J., 1999, “Quality Utility—A Compromise Programming Approach to Robust Design,” Journal of Mechanical Design, 121(2), pp. 179-187],

U=Σ∂ⱼ(Σ(βᵢⱼxᵢⱼ₁²+βᵢⱼ₂xᵢⱼ+βᵢⱼ₃))

where xᵢⱼ is the attribute value i for principal component j and βᵢⱼ₁ . . . β_{ij 3} are the associated attribute weights. An additional discrete weight (∂ⱼ) represents the principal component j.

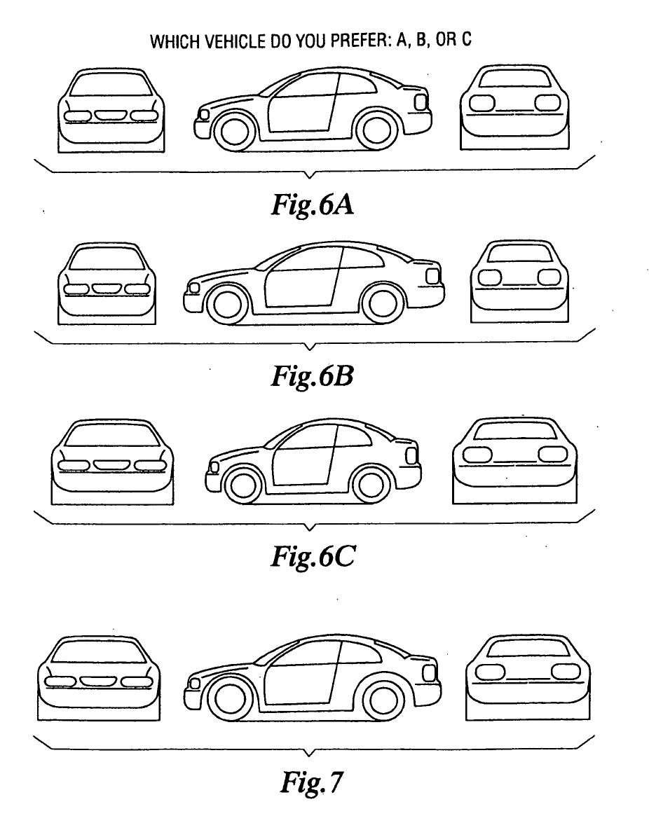

In the main example, a choice-based conjoint analysis was used to determine the initial values for the attribute weights. A potential consumer was asked 36 questions. Each question presented 3 vehicles that varied the attributes based upon their principal component (FIG. 6). For representation purposes, the rest of the vehicle was scaled accordingly. The results of the survey were analyzed using a LOGIT model. Other techniques could be used, such as PROBIT. The LOGIT model produced discrete weights for each attribute in the principal component. A spline was then mapped to the discrete weights which can be described using a third-order polynomial. The values from this polynomial are then used as the initial weights in the utility function, for example:

U=∂₁[(−1.02x₁₁²+77.77x₁₁−1466.60)+(−0.13x₁₂²+14.05x₁₂−3213.00)+(15.16x₁₃²−429.87x₁₃+2941.20)]+∂₂[(0.04x₂₂²−12.09x₂₂+1023.80)+(−14.96x₂₃²+436.40x₂₃−3168.50)+(0.29x₂₄²−3.43x₂₄+11.36)]

Once the initial values for the attribute weights are found, the utility function can be used as is or can be passed back through the program for further refinement. When this utility function is passed back to the manager agent 42, if the utility function is new, the characteristic agent's 44 weights and the shape's objective function are updated. In the embodiment and main example, for example, if the user showed a strong preference for a certain shape relation between track width and tire radius, those agents would be given a higher weight. Then, in the design evaluation, the agents would have more influence on the final design. The objective function for the components would also be updated to reflect the user's preference for the shape relationship. Then, through. the statistical analysis, this would be updated in the user's utility function.

The program-user-analysis-utility cycle is repeated for a set number of iterations or until the utility function ceases to change significantly, as determined by the builder. The final utility function is a quantification of the user's aesthetic preference for the design language. This quantification can then be represented pictorially. In the example, a final vehicle was generated based upon potential consumer's utility function (FIG. 7).

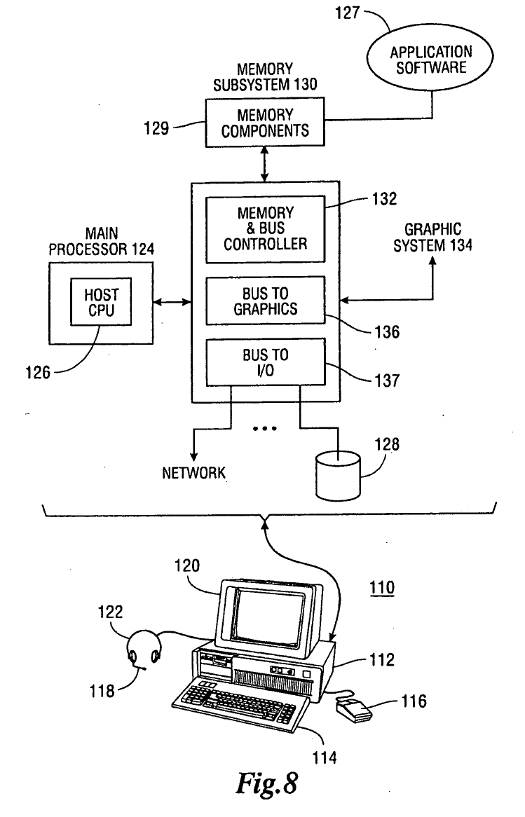

FIG. 8 is a block diagram of hardware 110 which may be used to implement the various embodiments of the method of the present invention. The hardware 110 may be a personal computer system comprised of a computer 112 having as input devices keyboard 114, mouse 116, and microphone 118. Output devices such as a monitor 120 and speakers 122 may also be provided. The reader will recognize that other types of input and output devices may be provided and that the present invention is not limited by the particular hardware configuration.

Residing within computer 112 is a main processor 124 which is comprised of a host central processing unit 126 (CPU). Software applications 127, such as the method of the present invention, may be loaded from, for example, disk 128 (or other device), into main memory 129 from which the software application 127 may be run on the host CPU 126. The main processor 124 operates in conjunction with a memory subsystem 130. The memory subsystem 130 is comprised of the main memory 129, which may be comprised of a number of memory components, and a memory and bus controller 132 which operates to control access to the main memory 129. The main memory 129 and controller 132 may be in communication with a graphics system 134 through a bus 136. Other buses may exist, such as a PCI bus 137, which interfaces to I/O devices or storage devices, such as disk 128 or a CDROM, or to provide network access.

Those of ordinary skill in the art will recognize that many modifications and variations of the present invention may be implemented. For example, although the foregoing description contains references to shape grammars, any type of product design rules may be used, for example, production system rules. Various types of analyses may be used, and means other than software agents may be utilized so as to enable the design space to be search through applications of the various product design rules. The foregoing description and the following claims are intended to cover all such modifications and variations.

What is claimed is:

1. A method, comprising:
performing a statistical analysis on product shape information;
identifying product characteristics based on statistical relationships among shapes in the product shape information;
generating a plurality of production rules that express the allowable variations of shapes defining the product characteristics; and
saving the generated rules for use in generating product designs according to the application of the rules.

2. The method of claim 1 wherein said performing a statistical analysis comprises performing one of a multi-dimensional scaling of normalized product shape information, decision tree analysis, factor analysis, or multi-variant analysis of shape information of the associations among the shapes.

3. The method of claim 1 additionally comprising using said statistical analysis to generate an initial preference function.

4. The method of claim 1 additionally comprising:
controlling the application of the production rules through a plurality of characteristic software agents whereby each characteristic software agent controls the application of the production rules to its assigned characteristic to generate a portion of a candidate design.

5. The method of claim 4 additionally comprising:
defining an initial preference function; and
using the production rules, with said initial preference function, to generate a plurality of candidate designs.

6. The method of claim 5 wherein said defining an initial preference function comprises defining one of an initial utility function, value function, or preference ordering.

7. The method of claim 5 additionally comprising:
obtaining consumer responses to said plurality of candidate designs.

8. The method of claim 7 additionally comprising:
inferring consumer preference based on said consumer responses.

9. The method of claim 8 additionally comprising;
using said consumer preference to update said initial preference function.

10. A method, comprising:
performing a statistical analysis on product shape information;
identifying product characteristics based on statistical relationships among shapes in the product shape information;
generating a plurality of shape grammar rules that express the allowable transformations for shapes defining the product characteristics; and
saving the generated shape grammar rules for use in generating product designs according to the application of the rules.

11. The method of claim 10 wherein said performing a statistical analysis comprises performing one of a multi-dimensional scaling of normalized product shape information, decision tree analysis, factor analysis, or multi-variant analysis of shape information of the associations among shapes.

12. The method of claim 10 additionally comprising using said statistical analysis to generate an initial preference function.

13. The method of claim 10 additionally comprising:
controlling the application of the shape grammar rules through a plurality of characteristic software agents whereby each characteristic software agent controls the application of the shape grammar rules to its assigned characteristic to generate a portion of a candidate design.

14. The method of claim 13 additionally comprising:
defining an initial preference function; and
using the shape grammar rules, with said initial preference function, to generate a plurality of candidate designs.

15. The method of claim 14 wherein said defining an initial preference function comprises defining one of an initial utility function, value function, or preference ordering.

16. The method of claim 14 additionally comprising:
obtaining consumer responses to said plurality of candidate designs.

17. The method of claim 16 additionally comprising:
inferring consumer preference based on said consumer responses.

18. The method of claim 17 additionally comprising;
using said consumer preference to update said initial preference function.

19. A computer implemented method, comprising:
enabling a plurality of characteristic software agents to control the application of production rules to that agent's assigned characteristic so that each characteristic software agent generates a portion of a candidate design;
determining if each of said portions of a candidate design is to be saved;
saving a plurality of completed candidate designs;
obtaining consumer responses to said plurality of candidate designs; and
identifying consumer preferences from said consumer responses.

20. The method of claim 19 additionally comprising:
defining an initial preference function,
using said initial preference function to determine an objective function for each of said characteristics, said objective functions being used to determine if portions of a candidate design are to be saved.

21. The method of claim 20 wherein said defining an initial preference function comprises defining one of an initial utility function, value function, or preference ordering.

22. The method of claim 19 wherein said application of production rules includes the application of shape grammar rules.

23. The method of claim 20 additionally comprising updating said initial preference function based on said consumer preferences.

24. The method of claim 19 wherein said identifying consumer preferences comprises performing a statistical analysis.

25. A computer readable medium carrying a set of instructions which, when implemented, perform a method, comprising:
performing a statistical analysis on a database of product shape information;
identifying product characteristics based on statistical relationships among the shapes in the product database;
generating a plurality of production rules that express the allowable variations of shapes defining the product characteristics; and
saving the generated rules in a database for use in generating product designs according to the application of the rules.

26. The medium of claim 25 wherein said production rules are shape grammar rules
